(19) United States
(12) Patent Application Publication
(10) Pub. No.: US 2023/0196653 A1
(43) Pub. Date: Jun. 22, 2023

(54) INFORMATION PROCESSING DEVICE, GENERATION METHOD, AND RENDERING METHOD

(71) Applicant: SONY GROUP CORPORATION, Tokyo (JP)

(72) Inventors: Goh KOBAYASHI, Tokyo (JP); Yoichi HIROTA, Kanagawa (JP)

(73) Assignee: SONY GROUP CORPORATION, Tokyo (JP)

(21) Appl. No.: 17/914,594

(22) PCT Filed: Mar. 19, 2021
(86) PCT No.: PCT/JP2021/011321

§ 371 Date: Sep. 26, 2022

(30) Foreign Application Priority Data
Apr. 3, 2020 (JP) 2020-067790

(51) Int. Cl. G06T 15/04; G06T 7/40; G06T 15/20

(52) U.S. Cl. CPC G06T 15/04; G06T 7/40; G06T 15/205

(57) ABSTRACT

There is provided an information processing device, a generation method, and a rendering method that makes it possible to generate a high-quality image while curbing a rendering load. The information processing device of the present technology is a device including a generation unit that generate a plurality of pieces of texture information corresponding to an image when an object is imaged at a plurality of different viewpoints, from texture information corresponding to 3D shape data indicating a shape of the object. The present technology can be applied to an information processing system that generates and transfers 3D data that is used for rendering.

### TECHNICAL FIELD

The present technology relates to an information processing device, a generation method, and a rendering method, and more particularly, to an information processing device, a generation method, and a rendering method capable of generating a high-quality image while curbing a rendering load.

### BACKGROUND ART

Various technologies have been proposed as methods for generating or transferring 3D data. For example, a method in which a 3D model and a UV texture image of an object are transferred to a device on the reproduction side and display is performed on the reproduction side has been proposed.

When 3D data is expressed in a format of a 3D model and a UV texture image, an amount of 3D data becomes small and a rendering load becomes low.

### CITATION LIST

### Patent Literature

[PTL 1]
Japanese Translation of PCT Application No. 2019-534511

### SUMMARY

### Technical Problem

Image quality of a viewing viewpoint image generated by rendering using a 3D model and a UV texture image is proportional to accuracy of the 3D model. For example, when the 3D model is larger than an actual object, the texture may be shifted or the texture may be stretched and unnatural.

As a technology for reducing the unnaturalness caused by stretching the texture, for example, PTL 1 proposes a technology for rendering using a flow UV map. The flow UV map is information indicating a method for stretching a texture to minimize visibility of distortion from a virtual camera.

However, when the flow UV map is used, an amount of data used for rendering becomes enormous, and a calculation cost is high.

Therefore, there is a demand for a 3D data format allowing a high-quality image to be generated by rendering, with small data and a curbed rendering load.

The present technology has been made in view of such a situation, and makes it possible to generate a high-quality image while curbing a rendering load.

### Solution to Problem

An information processing device of a first aspect of the present technology includes a generation unit configured to generate a plurality of pieces of texture information corresponding to an image when an object is imaged at a plurality of different viewpoints, from texture information corresponding to 3D shape data indicating a shape of the object.

An information processing device of a second aspect of the present technology includes a rendering unit configured to perform rendering using a plurality of pieces of texture information corresponding to an image when an object is imaged from a plurality of different viewpoints.

In the first aspect of the present technology, a plurality of pieces of texture information corresponding to an image when an object is imaged at a plurality of different viewpoints are generated, from texture information corresponding to 3D shape data indicating a shape of the object.

In the second aspect of the present technology, rendering is performed by using a plurality of pieces of texture information corresponding to an image when an object is imaged from a plurality of different viewpoints.

### BRIEF DESCRIPTION OF DRAWINGS

FIG. 1 illustrates a series of flows from generation of a captured image to viewing of the image.

FIG. 2 is a diagram illustrating an example of a data format of general 3D data.

FIG. 3 is a diagram illustrating an example of projection of UV texture information.

FIG. 4 is a diagram illustrating another example of the projection of UV texture information.

FIG. 5 is a diagram illustrating still another example of the projection of UV texture information.

FIG. 6 is a diagram illustrating an example of an optimized camera.

FIG. 7 is a diagram illustrating an example of optimization of UV texture information when an imaging device cam is selected as the optimized camera.

FIG. 8 is a diagram illustrating an example of a data format of 3D data of the present technology.

FIG. 9 is a diagram illustrating an example of a rendering method of the present technology.

FIG. 10 is a diagram illustrating an example of a rendering method of the present technology.

FIG. 11 is a block diagram illustrating a configuration example of an information processing system to which the present technology is applied.

FIG. 12 is a diagram illustrating a disposition example of an imaging device.

FIG. 13 is a block diagram illustrating a configuration example of a 3D model generation unit.

FIG. 14 is a block diagram illustrating a configuration example of a rendering unit.

FIG. 15 is a diagram illustrating an example of a method of determining importance P(i).

FIG. 16 is a diagram illustrating another example of the method of determining the importance P(i).

FIG. 17 is a diagram illustrating still another example of the method of determining the importance P(i).

FIG. 18 is a diagram illustrating an example of a blend offset coefficient according to the passage of viewing time.

FIG. 19 is a flowchart illustrating a flow of processing that is executed by an information processing system.

FIG. 20 is a flowchart illustrating a flow of UV texture information generation processing when a virtual camera is selected as an optimized camera.

FIG. 21 is a flowchart illustrating a flow of UV texture information generation processing when an imaging device cam is selected as an optimized camera.

FIG. 22 is a flowchart illustrating UV texture information selection processing.

FIG. 23 is a flowchart illustrating a flow of blend coefficient calculation processing when a blend coefficient blend_1st is set to gradually increase with the passage of viewing time.

FIG. 24 is a flowchart illustrating viewing viewpoint image generation processing.

FIG. 25 is a block diagram illustrating a configuration example of computer hardware.

### DESCRIPTION OF EMBODIMENTS

Hereinafter, modes for implementing the present technology will be described. Description will be given in the following order.

1. Overview of Information Processing System

2. Configuration of Information Processing System

3. Operation of Information Processing System

4. Application Examples

5. Computer

### 1. Overview of Information Processing System

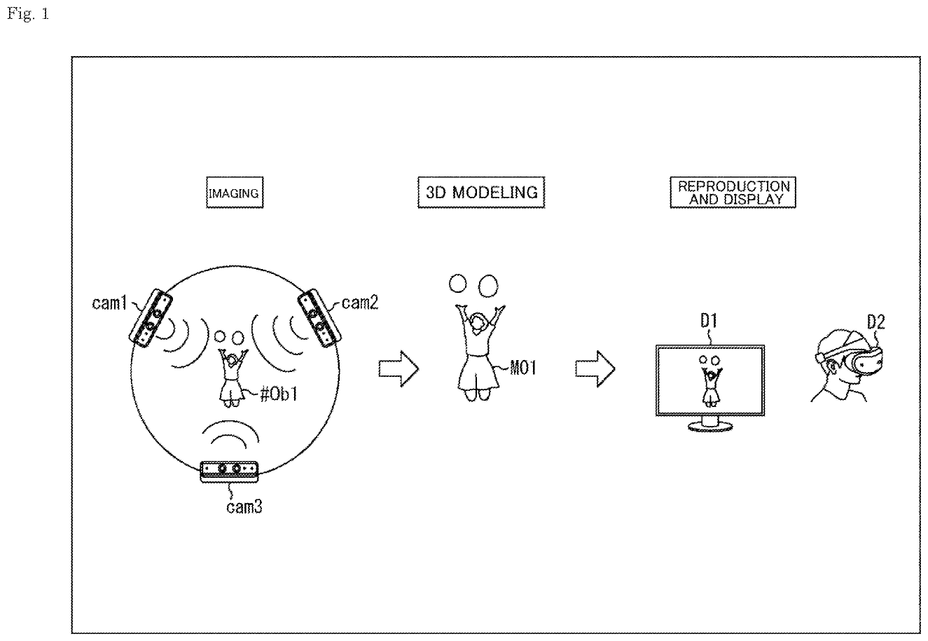

FIG. 1 illustrates a series of flows from generation of a captured image to viewing of the image.

In FIG. 1, an example in which imaging is performed with a person performing a predetermined operation as an object #Ob1 using three imaging devices cam1 to cam3 is illustrated. As illustrated on the left side of FIG. 1, three imaging devices cam1 to cam3 disposed to surround the object #Ob1 image the object #Ob1.

In the following description, when it is not necessary to distinguish the imaging devices cam1 to cam3, the imaging devices cam1 to cam3 are simply referred to as an imaging device cam in the description. The same applies to other configurations in which a plurality of imaging devices are provided.

3D modeling is performed using captured images obtained from a plurality of imaging devices cam disposed at different positions, and a 3D model MO1 of the object #Ob1 is generated, as illustrated at the center of FIG. 1. The 3D model MO1 is generated by using, for example, a scheme such as Visual Hull of performing cutout of a three-dimensional shape using a captured image obtained by imaging the object #Ob1 from different directions.

Data of the 3D model (3D data) of the object generated as described above is transferred to a device on the reproduction side and is reproduced. That is, in the device on the reproduction side, the rendering of the 3D model is performed on the basis of the 3D data, so that a viewing viewpoint image is displayed on a viewing device. In FIG. 1, a display D1 and a head-mounted display (HMD) D2 are shown as the viewing device that is used by the viewer.

General 3D Data

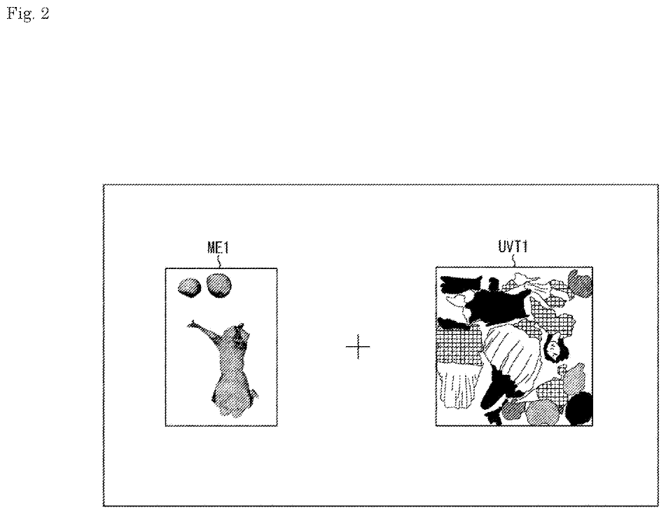

FIG. 2 is a diagram illustrating an example of a data format of general 3D data.

As illustrated in FIG. 2, the 3D data is generally expressed by 3D shape data ME1 indicating a 3D shape (geometry information) of an object and UV texture information UVT1 indicating color information of the object.

The 3D shape data ME1 is expressed in a format of mesh data in which shape information indicating a surface shape of the object is expressed by a connection between a vertex and a vertex called a polygon mesh. A method of expressing the 3D shape data ME1 is not limited thereto, and the 3D shape data ME1 may be described by a so-called point cloud expression method in which expression is performed with position information of points.

The UV texture information UVT1 is, for example, information in a map format in which a texture pasted to each polygon mesh or each point, which is 3D shape data, is expressed in a UV coordinate system and held.

The UV texture information UVT1 is generated by projecting a texture generated by using an image obtained by imaging in the imaging device cam onto the 3D model MO1, and associating projected parts on the 3D model MO1 and a texture of each projected part.

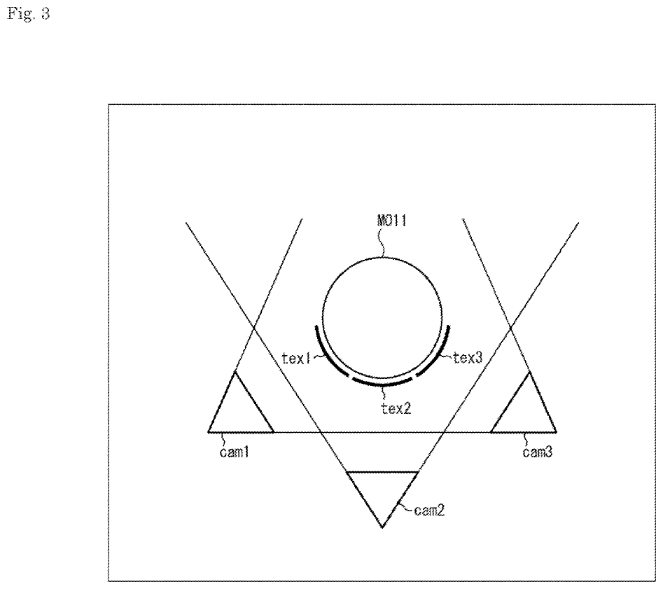

FIG. 3 is a diagram illustrating an example of the projection of UV texture information.

When a size of a 3D model MO11 generated by 3D modeling is the same as a size of an actual object, camera textures tex1 to tex3 are projected onto the 3D model MO11 without deviation as illustrated in FIG. 3.

The camera texture tex1 is a texture generated by using an image captured by the imaging device cam1, and the camera texture tex2 is a texture generated by using an image captured by the imaging device cam2. Further, the camera texture tex3 is a texture generated by using an image captured by an imaging device cam3. The imaging devices cam1 to cam3 are installed in an actual imaging space.

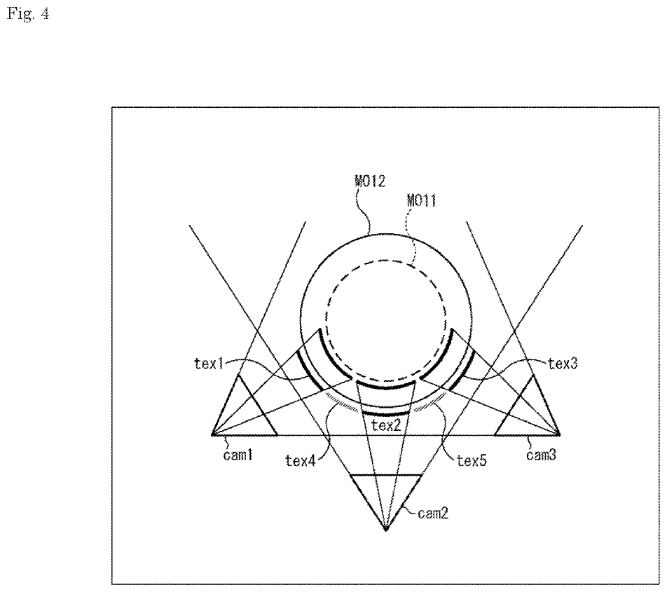

FIG. 4 is a diagram illustrating another example of the projection of UV texture information.

As illustrated in FIG. 4, when a 3D model MO12 generated by 3D modeling is larger than the 3D model MO11 (the actual object) described above, the camera texture tex1 and the camera texture tex2 are projected in a state in which a gap is generated between these camera textures. Further, the camera texture tex2 and the camera texture tex3 are projected in a state in which a gap is generated between these camera textures.

In this case, the camera texture of the imaging device cam with an angle of view close to a normal direction of each of meshes constituting the 3D model MO12 is projected onto the gap generated between the camera textures. For example, a camera texture tex4 that is a mixture of a camera texture of the imaging device cam1 and a camera texture of the imaging device cam2 is projected onto a gap generated between the camera texture tex1 and the camera texture tex2. Further, a camera texture tex5 that is a mixture of the camera texture of the imaging device cam2 and a camera texture of the imaging device cam3, is projected onto a gap generated between the camera texture tex2 and the camera texture tex3.

Using the texture projected in this way, UV texture information to be transferred together with 3D shape data of the 3D model MO12 larger than the actual object is generated. Therefore, in the UV texture information, a shift or a double image is generated between camera textures of different imaging devices cam.

Similarly, in a case in which a shape of the 3D model differs from a shape of the actual object, such as a case in which the 3D model is smaller than the actual object, the shift or the double image is generated between the camera textures of the different imaging devices cam.

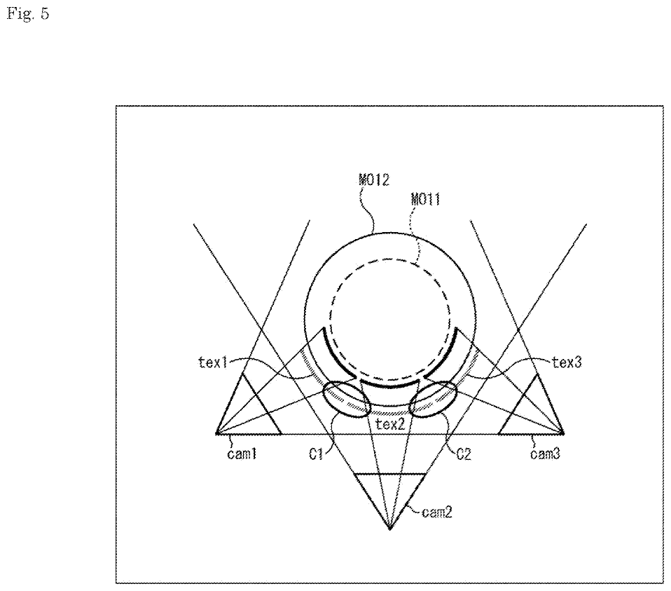

FIG. 5 is a diagram illustrating still another example of the projection of UV texture information.

In the example of FIG. 5, matching is achieved by stretching the camera textures tex1 to tex3 in order to prevent the shift or the double image of the texture that is generated in the case described with reference to FIG. 4.

For example, a part of a right end of the stretched camera texture tex1 and a part of a left end of the stretched camera texture tex2 are projected onto a region of the 3D model included in an oblong elliptical circle C1. Further, a part of a right end of the stretched camera texture tex2 and a part of a left end of the stretched camera texture tex3 are projected onto a region of the 3D model included in an oblong elliptical circle C2.

The generation of the shift or the double image of texture is prevented by stretching and projecting the camera textures tex1 to tex3, but a rendering result based on the 3D data including the projected camera texture may look unnatural because the texture is stretched and contracted.

By changing the way that the camera texture is stretched according to the viewing viewpoint, it is possible to reduce the unnatural appearance of the rendering result. However, because it is necessary to hold a flow UV map showing the way to stretch a texture, an amount of 3D data becomes enormous. Further, at the time of rendering, it is necessary to calculate the way to stretch a texture in real time, and a calculation cost is required on the reproduction side.

Therefore, in the present technology, UV texture information optimized for an angle of view of an optimized camera is generated.

The optimized camera is a camera whose UV texture information is optimized so that a 3D model onto which a camera texture is projected looks natural. Hereinafter, a position and direction of the optimized camera is referred to as an optimized viewpoint. The viewpoint is assumed to include a position and a direction. Further, the UV texture information optimized for the optimized camera is UV texture information corresponding to an image in a case in which an object is imaged at an angle of view of the optimized camera.

Method of Generating UV Texture Information of the Present Technology

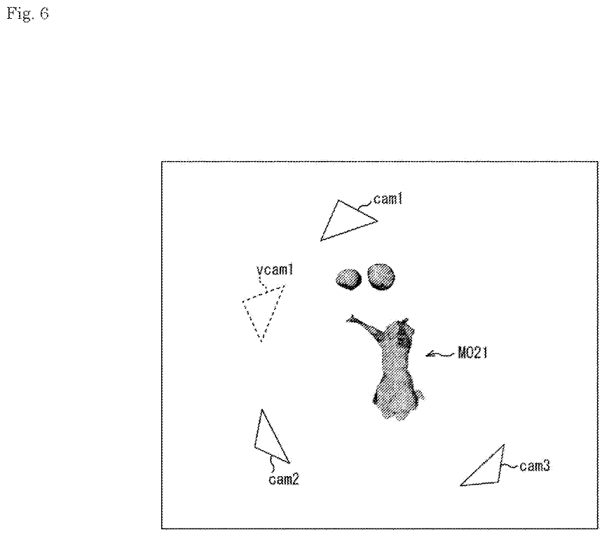

FIG. 6 is a diagram illustrating an example of an optimized camera.

As illustrated in FIG. 6, the distribution side generates UV texture information optimized for an angle of view of an optimized camera vcam1 by using the captured images obtained by imaging in the imaging devices cam1 to cam3.

The optimized camera vcam1 can be a virtual camera or can be any imaging device cam that is actually installed.

When the optimized camera vcam1 is a virtual camera, the distribution side first projects the camera texture generated using the captured images of the imaging devices cam1 to cam3 onto the 3D model MO21 to generate the UV texture information corresponding to the 3D model MO21. Here, stretching of a texture is allowed.

The distribution side selects N different virtual cameras as optimized cameras. For example, a virtual camera with an angle of view at which a viewer is likely to view, such as a front of the 3D model, is selected as the optimized camera.

A user on the distribution side (for example, a creator of 3D content in a vertical direction) corrects the UV texture information with an angle of view of a certain optimized camera (i) (i∈N) among the selected N virtual cameras so that there is no unnaturalness. The corrected UV texture information is stored as UV texture information (i) optimized for the optimized camera (i).

Processing of correcting the UV texture information according to an operation of the user on the distribution side and storing the UV texture information (i) is performed for each of the N optimized cameras (i). Accordingly, N pieces of UV texture information (i) are stored.

As described above, when the user on the distribution side can make correction, texture information optimized for the angle of view of each virtual camera is generated.

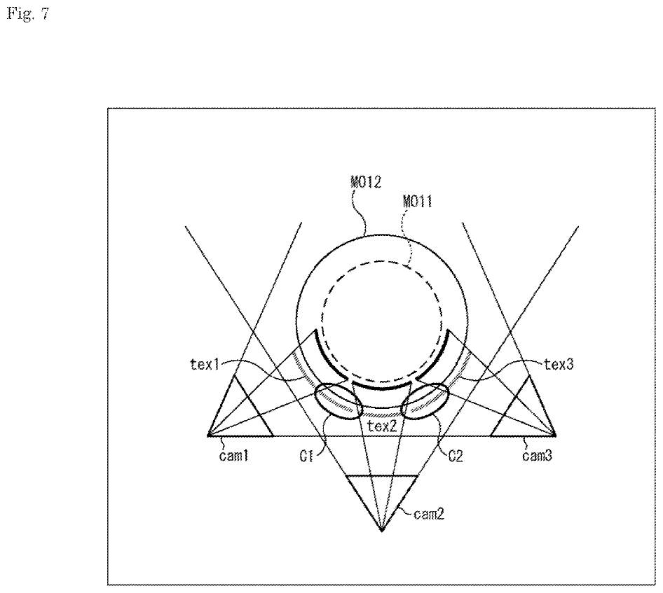

FIG. 7 is a diagram illustrating an example of optimization of UV texture information in a case in which the imaging device cam is selected as an optimized camera.

The distribution side selects N different imaging devices cam as the optimized cameras. For example, the imaging device cam with an angle of view at which the viewer is likely to view, such as a front of an object, is selected as the optimized camera.

The distribution side processes the camera texture generated by using a captured image obtained by imaging in the imaging device cam other than the certain optimized camera (i) among the selected N imaging devices cam to generate the UV texture information (i).

FIG. 7 illustrates an example of a case in which the imaging device cam2 is selected as the optimized camera (i). As illustrated in FIG. 7, the camera texture text generated by using the captured image obtained by imaging in the imaging device cam2 becomes a texture projected onto the 3D model MO12 without being processed.

On the other hand, the camera texture tex1 generated by using a captured image obtained by imaging in the imaging device cam1 is stretched and becomes a texture in which a part of a right end is projected onto a region of the 3D model MO12 included in the circle C1. Further, the camera texture tex3 generated by using the captured image obtained by imaging in the imaging device cam3 is stretched and becomes a texture in which a part of the left end is projected onto a region of the 3D model MO12 included in the circle C2.

The UV texture information optimized for the angle of view of the imaging device cam2 in this way is stored as the UV texture information (i).

The processing for appropriately processing the texture and storing the UV texture information (i) is performed for each of the N optimized cameras (i). Accordingly, the N pieces of UV texture information (i) are stored.

Because there are a large number of types of UV texture information (i) when the number of imaging devices cam is large, it is an effective scheme to generate the UV texture information (i) optimized for the angle of view of the imaging device cam.

Although the case in which the UV texture information is corrected by the user on the distribution side in order to optimize the UV texture for an angle of view of the virtual camera has been described with reference to FIG. 6, UV texture information with little stretching may be automatically generated at the angle of view of the optimized camera (i) using an existing scheme by the device on the distribution side.

In this case, the UV texture information optimized for the angle of view of the optimized camera (i) by the device on the distribution side is stored as the UV texture information (i). Processing for optimizing and storing the UV texture information is performed on each of the angles of view of the N optimized cameras. Accordingly, N pieces of UV texture information are stored.

When the number of imaging devices cam is small, the device on the distribution side automatically generates the UV texture information (i), so that a larger number of pieces of UV texture information (i) than the number of imaging devices cam are generated. Therefore, when the number of imaging devices cam is small, it is an effective scheme to automatically generate the UV texture information (i) using the device on the distribution side.

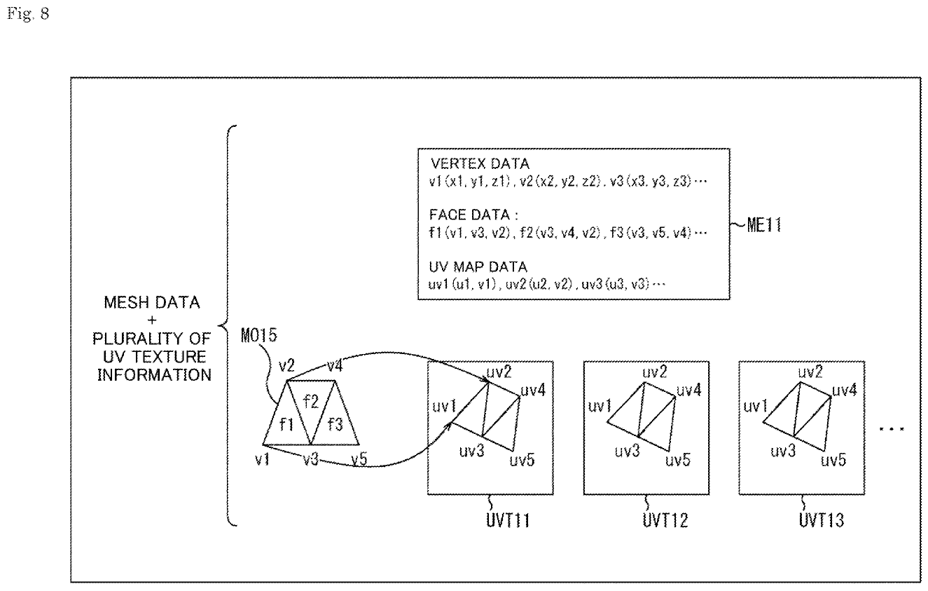

FIG. 8 is a diagram illustrating an example of a data format of 3D data of the present technology.

As illustrated on the left side of FIG. 8, the 3D data of the present technology is expressed by single mesh data and a plurality of pieces of UV texture information.

As illustrated in an upper part of the center of FIG. 8, the mesh data ME11 consists of vertex data (an xyz coordinate value), face data (a vertex index), and UV map data (a uv coordinate value).

The vertex data and the face data are, for example, 3D shape data indicating a 3D shape of a trapezoidal 3D model MO15. In the example of FIG. 8, the face data indicates that a face f1 is formed by vertices v1, v2, and v3, a face f2 is formed by vertices v2, v3, and v4, and a face f3 is formed by vertices v3, v4, and v5. The vertex data indicates positions of the vertices v1 to v5.

As UV texture information corresponding to 3D shape data, the UV texture information UVT1 to UVT3 optimized for angles of view of different optimized cameras is associated with mesh data ME11.

For example, the UV texture information UVT1 is UV texture information optimized for an angle of view of the imaging device cam1, and UV texture information UVT2 is UV texture information optimized for the angle of view of the imaging device cam2. Further, the UV texture information UVT3 is UV texture information optimized for the angle of view of the imaging device cam3.

The UV map data indicates coordinates of points on the UV texture corresponding to the vertices represented by the vertex data. That is, it can be said that the UV map data is mapping information indicating a correspondence relationship between the 3D shape data and the UV texture information UVT1 to UVTV3. For example, the UV map data indicates that the vertex v1 corresponds to a point uv1 on the UV texture information, and the vertex v2 corresponds to a point uv2 on the UV texture information.

Thus, each of the plurality of pieces of UV texture information corresponds to common single mapping information. The 3D data is transferred from the distribution side to the reproduction side, and is used for rendering of the 3D model on the reproduction side.

The plurality of pieces of UV texture information may be generated as independent data and transferred to the reproduction side. For example, among the plurality of pieces of UV texture information generated by the distribution side, the UV texture information according to the viewing viewpoint may be selected and transferred to the reproduction side, or the number of pieces of UV texture information according to a band used for transfer may be selected and transferred to the reproduction side.

When the plurality of pieces of UV texture information are generated as independent data, the distribution side can control the transfer of the UV texture information according to the viewing viewpoint or the band.

Rendering Method of the Present Technology

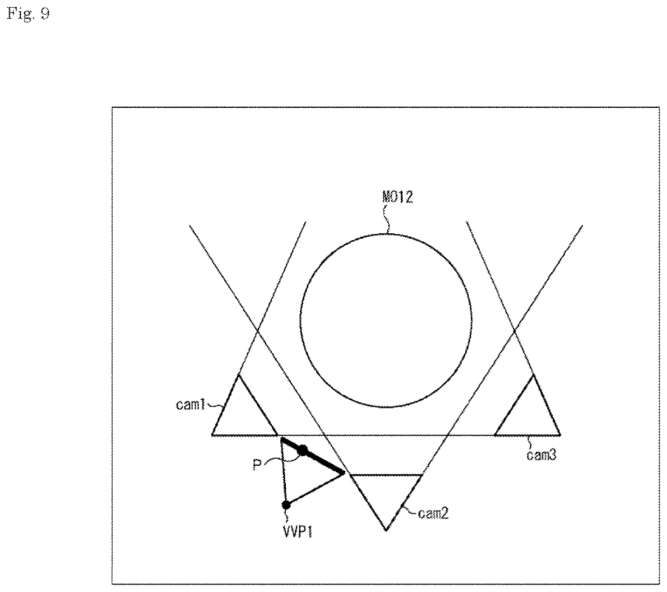

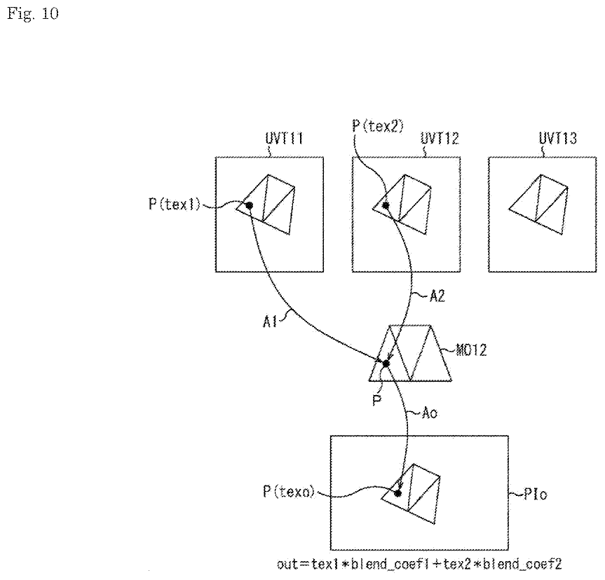

Next, a rendering method based on the above-described 3D data will be described with reference to FIGS. 9 and 10.

FIG. 9 is a diagram illustrating an example of a rendering method of the present technology.

As illustrated in FIG. 9, the reproduction side sets a viewing viewpoint VVP1 when rendering the 3D model MO12. The viewing viewpoint VVP1 indicates a virtual viewpoint of the viewer.

The reproduction side selects a plurality of pieces of UV texture information on the basis of the viewing viewpoint VVP1 and performs blending in units of pixels of the viewing viewpoint image. When one piece of UV texture information is selected, the UV texture information used for rendering may be switched to the selected UV texture information.

For example, an example in which blending of UV texture information is performed on a pixel at the point P on the viewing viewpoint image, which is an image of the 3D model MO12 seen from the viewing viewpoint VVP1, will be described. In FIG. 9, a thick line passing through the point P indicates the viewing viewpoint image of the 3D model MO12 at the viewing viewpoint VVP1.

For example, as illustrated in an upper part of FIG. 10, it is assumed that three pieces of UV texture information UVT11 to UVT13 have been transferred from the distribution side. In this case, the reproduction side selects the UV texture information UVT11 and the UV texture information UVT12 in which the optimized viewpoint is set at a position close to the viewing viewpoint VVP1 on the basis of the viewing viewpoint VVP1 and the optimized viewpoint of the UV texture information UVT11 to UVT13.

Further, as indicated by arrows A1 and A2, the reproduction side acquires a pixel value of the point P (tex1) and a pixel value of the point P (tex2) corresponding to the point P on the 3D model MO12 on the basis of the UV map data from the UV texture information UVT11 and the UV texture information UVT12, and blends the pixel values.

The reproduction side stores (sets) a pixel value obtained by blending the pixel value of the point P (tex1) and the pixel value of the point P (tex2), as a pixel value of a point P (texo) of a viewing viewpoint image PIo, which is an image of the 3D model seen from the viewing viewpoint VVP1, as indicated by an arrow Ao.

In this case, a pixel value out obtained by blending the pixel value tex1 of the point P (tex1) and the pixel value tex2 of the point P (tex2) is calculated as in Equation (1) below.

out=tex1*blend_coef1+tex2*blend_coef2 (1)

Here, blend_coef1 indicates a blend coefficient of the pixel value of the UV texture information UVT11, and blend_coef2 indicates a blend coefficient of the pixel value of the UV texture information UVT12. A method of calculating the blend coefficient will be described below.

Processing for blending the pixel values of the plurality of pieces of UV texture information in this way is performed on each pixel of the viewing viewpoint image.

As described above, on the distribution side, different optimized cameras are determined, and the plurality of pieces of UV texture information optimized for the angle of view of the optimized camera are generated. The plurality of pieces of UV texture information generated by the distribution side is transferred to the reproduction side.

The reproduction side blends the UV texture information optimized in advance so that the 3D model looks natural when the 3D model is viewed from an optimization position close to the viewing viewpoint, among the plurality of pieces of UV texture information transferred from the distribution side, to generate the viewing viewpoint image. Because the reproduction side may not perform high load processing such as calculation of stretching of the texture, it is possible to generate a high-quality viewing viewpoint image with a low rendering load.

### 2. Configuration of Information Processing System

Configuration of Entire Information Processing System

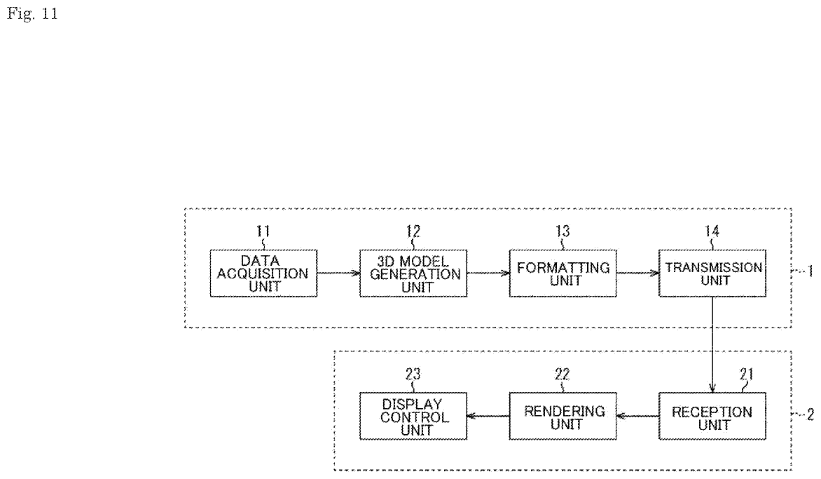

Next, a system to which the present technology described above is applied will be described. FIG. 11 is a block diagram illustrating a configuration example of an information processing system to which the present technology has been applied.

As illustrated in FIG. 11, the information processing system includes a distribution device 1 and a reproduction device 2. The distribution device 1 and the reproduction device 2 are connected via a network such as the Internet, a wireless local area network (LAN), or a cellular network.

The distribution device 1 is an information processing device that generates 3D data including the mesh data and the plurality of pieces of UV texture information. The distribution device 1 applies the present technology described above to generate the 3D data.

The distribution device 1 includes a data acquisition unit 11, a 3D model generation unit 12, a formatting unit 13, and a transmission unit 14.

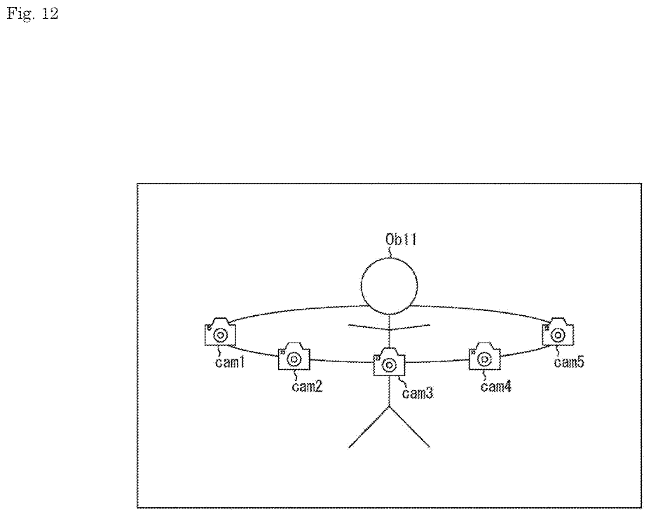

The data acquisition unit 11 acquires image data for generating a 3D model of an object. For example, as illustrated in FIG. 12, a plurality of viewpoint images captured by five imaging devices cam1 to cam5 disposed to surround an object Ob11 are acquired as image data. In this case, the plurality of viewpoint images are preferably images captured by a plurality of cameras in synchronization.

Further, the data acquisition unit 11 may acquire, for example, a plurality of viewpoint images obtained by imaging the object from a plurality of viewpoints using one camera as image data. Further, the data acquisition unit may acquire, for example, one captured image of the object as image data. In this case, the 3D model generation unit 12 to be described below generates a 3D model by using, for example, machine learning.

The data acquisition unit 11 may perform calibration on the basis of the image data and acquire internal parameters and external parameters of each imaging device cam. Further, the data acquisition unit 11 may acquire, for example, a plurality of pieces of depth information indicating distances from a plurality of viewpoints to the object.

The 3D model generation unit 12 generates a model having 3D information of the object on the basis of the image data for generating the 3D model of the object. The 3D model generation unit 12 uses, for example, a so-called Visual Hull to generate the 3D model of the object by shaving the three-dimensional shape of the object using images from a plurality of viewpoints (for example, silhouette images from a plurality of viewpoints).

In this case, the 3D model generation unit 12 can further transform the 3D model generated using Visual Hull with high accuracy by using the plurality of pieces of depth information indicating the distances from the plurality of viewpoints to the object.

Further, for example, the 3D model generation unit 12 may generate the 3D model of the object from one captured image of the object. The 3D model generated by the 3D model generation unit 12 can be said to be a moving image of the 3D model by being generated in units of time-series frames. Further, because the 3D model is generated by using the image captured by the imaging device cam, the 3D model can be said to be a live-action 3D model.

The 3D model generation unit 12 generates color information data as the plurality of pieces of UV texture information in a form linked to 3D shape data.

The formatting unit 13 converts data of the 3D model generated by the 3D model generation unit 12 into a format suitable for transfer and storage. For example, the 3D model generated by the 3D model generation unit 12 may be converted into a plurality of two-dimensional images by perspective projection from a plurality of directions.

In this case, the formatting unit 13 may generate depth information, which is a two-dimensional depth image from a plurality of viewpoints, using the 3D model.

The formatting unit 13 compresses the depth information and the color information in a state of this two-dimensional image and outputs resultant information to the transmission unit. The depth information and the color information may be transferred side by side as one image, or may be transferred as two separate images. In this case, because the information is in a form of two-dimensional image data, the information can also be compressed by using a two-dimensional compression technology such as advanced video coding (AVC).

Further, the formatting unit 13 may convert the 3D data into a point cloud format, for example. Further, the formatting unit 13 may output the 3D data as three-dimensional data to the transmission unit. In this case, it is possible to use, for example, a three-dimensional compression technology of Geometry-based-Approach discussed in MPEG.

The transmission unit 14 transfers the transfer data formed by the formatting unit 13 to the reception unit 21 of the reproduction device 2. The transmission unit 14 performs a series of processing of the data acquisition unit 11, the 3D model generation unit 12, and the formatting unit 13 offline and then transfers the transfer data to the reception unit 21. Further, the transmission unit 14 may transfer the transfer data generated from the series of processing described above to the reception unit 21 in real time.

The reproduction device 2 is an information processing device that renders a 3D model on the basis of the 3D data transferred from the distribution device 1.

The reproduction device 2 includes a reception unit 21, a rendering unit 22, and a display control unit 23.

The reception unit 21 receives the transfer data transferred from the transmission unit 14 and decodes the transfer data according to a predetermined format.

The rendering unit 22 performs rendering using the transfer data received by the reception unit 21. For example, a mesh of the 3D model is projected at the viewing viewpoint, and texture mapping is performed to paste a texture indicating a color or a pattern.

A display device detects a viewing place (a region of interest) of the viewer, and the viewing viewpoint data is input to the rendering unit 22 from the display device.

Further, for example, billboard rendering for rendering the object so that the object maintains a vertical posture with respect to the viewing viewpoint may be adopted. For example, when the rendering unit 22 renders a plurality of objects, the rendering unit 22 may render the objects with low interest of the viewer on a billboard and render the other objects using another rendering scheme.

The display control unit 23 displays a rendering result of the rendering unit 22 on a display unit of the display device. The display device may be a 2D monitor or a 3D monitor such as a head-mounted display, a spatial display, a mobile phone, a television, or a PC.

In FIG. 11, a series of flows from the data acquisition unit 11 that acquires the captured image, which is a material for generating content, to the display control unit 23 that controls the display device that is viewed by the viewer are illustrated. However, this does not mean that all functional blocks are required for implementation of the present invention, and the present invention can be implemented for each functional block or in a combination of a plurality of functional blocks.

For example, the transmission unit 14 or the reception unit 21 are provided in order to show a series of flows from the side that creates content to the side that views the content through distribution of content data in FIG. 11, it is not necessary to include the formatting unit 13, the transmission unit 14, and the reception unit 21 in a case in which the creation and the viewing of the content are performed by the same information processing device (for example, a personal computer).

When the present information processing system is implemented, the same implementer may implement everything or different implementers corresponding to the respective functional blocks may implement the information processing system. As an example, a business operator A generates 3D content through a data acquisition unit, a 3D model generation unit, and a formatting unit. Then, it is conceivable that the 3D content is distributed through a transmission unit (platform) of a business operator B, and a display device of a business operator C performs reception, rendering, and display control of the 3D content.

Further, each functional block can be implemented on the cloud. For example, the rendering unit 22 may be implemented in the display device or may be implemented in a server. In that case, information is exchanged between the display device and the server.

In FIG. 11, the data acquisition unit 11, the 3D model generation unit 12, the formatting unit 13, the transmission unit 14, the reception unit 21, the rendering unit 22, and the display control unit 23 are collectively described as an information processing system. However, in the present specification, when two or more functional blocks are related, the functional blocks are referred to as an information processing system, and for example, the data acquisition unit 11, the 3D model generation unit 12, the formatting unit 13, the transmission unit 14, the reception unit 21, and the rendering unit 22 except for the display control unit 23 can be collectively referred to as an information processing system.

Configuration of 3D Model Generation Unit

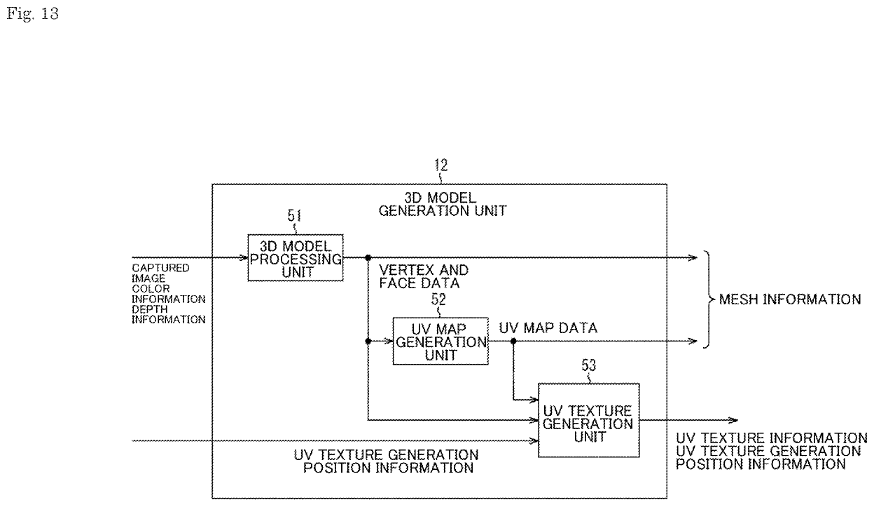

FIG. 13 is a block diagram illustrating a configuration example of the 3D model generation unit 12 (FIG. 11).

The 3D model generation unit 12 generates 3D shape data (vertices and faces) in a mesh format, the UV map data, and the plurality of pieces of UV texture information as color information in a UV map format.

As illustrated in FIG. 13, the 3D model generation unit 12 includes a 3D model processing unit 51, a UV map generation unit 52, and a UV texture generation unit 53.

The captured image, the color information, the depth information, and the like from the data acquisition unit 11 are supplied to the 3D model processing unit 51. For example, the same number of captured images as the number of imaging devices cam installed in an imaging space is supplied to the 3D model processing unit 51.

The 3D model processing unit 51 creates vertex and face data using a scheme such as Visual Hull, supplies the data to the UV map generation unit 52 and the UV texture generation unit 53, and outputs the data to a stage subsequent to the 3D model processing unit 51.

The UV map generation unit 52 generates UV map data indicating a correspondence relationship between the vertex and face data supplied from the 3D model processing unit 51 and the camera texture, supplies the UV map data to the UV texture generation unit 53, and also outputs the UV map data to a stage subsequent to the 3D model processing unit 51.

The UV map data generated by the UV map generation unit 52 is output as mesh information together with the vertex and face data generated by the 3D model processing unit 51.

UV texture generation position information is supplied to the UV texture generation unit 53 from the data acquisition unit 11. The UV texture generation position information is information (for example, a camera parameter) indicating the angle of view of the virtual camera or the imaging device cam selected as the optimized camera. For example, as the UV texture generation position information, internal parameters and external parameters of the plurality of imaging devices cam selected as the optimized cameras are supplied to the data acquisition unit 11.

Hereinafter, a case in which a plurality of imaging devices cam are selected as the optimized cameras will be described. In this case, the optimized viewpoint indicates a position and direction of the imaging device cam.

As the UV texture generation position information, information for designating each imaging device cam may be supplied to the UV texture generation unit 53.

The UV texture generation unit 53 generates a plurality of pieces of UV texture information optimized for the angles of view of the different optimized cameras on the basis of the vertex and face data supplied from the 3D model processing unit 51, the UV map data supplied from the UV map generation unit 52, and the UV texture generation position information.

The plurality of pieces of UV texture information generated by the UV texture generation unit 53 is output to a stage subsequent to the 3D model generation unit 12 together with the UV texture generation position information.

Configuration of Rendering Unit

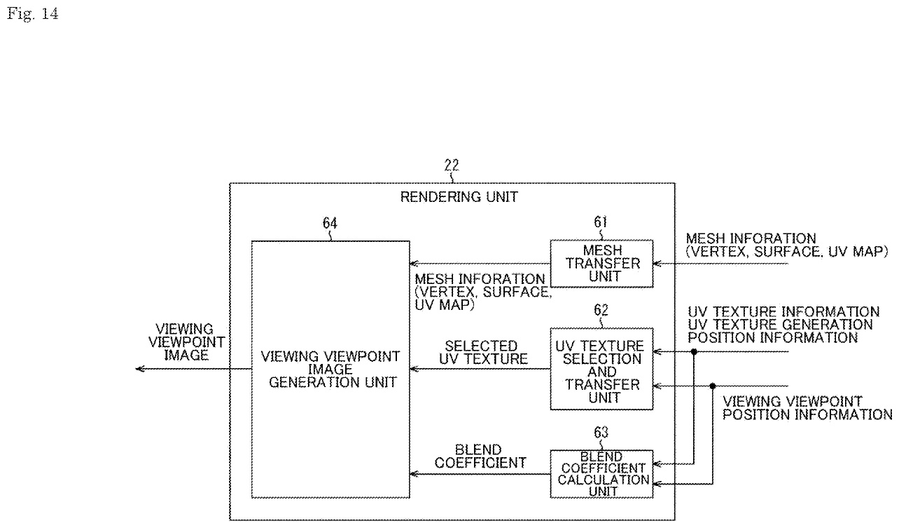

FIG. 14 is a block diagram illustrating a configuration example of the rendering unit 22 (FIG. 11).

The mesh information, the UV texture information, the UV texture generation position information, and viewing viewpoint position information are supplied to the rendering unit 22. The viewing viewpoint position information is information indicating the viewing viewpoint. The rendering unit 22 performs processing for generating a viewing viewpoint image on the basis of the supplied information.

As illustrated in FIG. 14, the rendering unit 22 includes a mesh transfer unit 61, a UV texture selection and transfer unit 62, a blend coefficient calculation unit 63, and a viewing viewpoint image generation unit 64.

The mesh transfer unit 61 supplies the vertex, face, and UV map acquired by the reception unit 21 to the viewing viewpoint image generation unit 64. This processing is processing for transferring the mesh information to a GPU memory, and can be omitted when the mesh information is transferred to the GPU memory at a point in time of reception.

The UV texture selection and transfer unit 62 selects only the UV texture information to be used from among the plurality of pieces of UV texture information according to the viewing viewpoint. Specifically, first, the UV texture selection and transfer unit 62 determines importance P(i) (i=1 to N) at each optimized viewpoint (i) on the basis of the viewing viewpoint indicated by the viewing viewpoint position information and the optimized viewpoint (i) indicated by the UV texture generation position information.

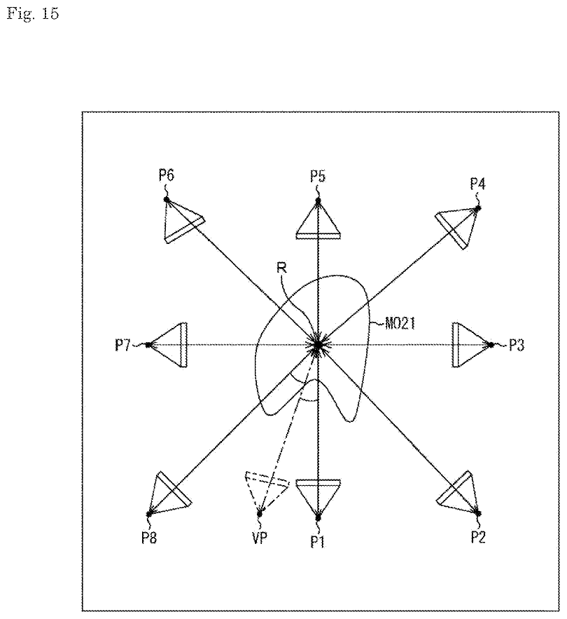

Here, an example of a method of determining the importance P(i) will be described with reference to FIGS. 15 to 17.

In FIG. 15, an example in which the importance P(i) of the respective optimized viewpoints P1 to P8 is calculated on the basis of an angle formed by a vector from the optimized viewpoints P1 to P8 to a position of the 3D model MO21 (a position of the object) and a vector from a viewing viewpoint VP to the position of the 3D model MO21 is shown. In this case, the importance P(i) is calculated by using Equation (2) below.

P(i)=1/arc cos(Ci·Cv) (2)

Here, Ci indicates a unit vector from an optimized viewpoint Pi to the position of the 3D model MO21. Cv indicates a unit vector from the viewing viewpoint VP to the position of the 3D model MO21. Ci·Cv indicates an inner product of the vector Ci and the vector Cv.

Therefore, the importance P(i) is inversely proportional to an angle formed by the vector Ci and the vector Cv, and the importance P(i) becomes higher when the angle formed by the vector Ci and the vector Cv is smaller. That is, the importance P(i) becomes higher for an optimized viewpoint at which a direction with respect to a position of the 3D model MO21 is closer to the viewing viewpoint.

The vector Ci and the vector Cv are set with reference to a representative point R of the object Ob11. The representative point R can be set by using any method.

For example, a point on the 3D model MO21 at which a total distance from axes indicating directions of the optimized viewpoints P1 to P8 and the viewing viewpoint VP is minimized is set as the representative point R. Alternatively, for example, a position in the middle of a maximum value and a minimum value of coordinates of vertices of the 3D model MO21 in each of an X direction, a Y direction, and a Z direction of a world coordinate system is set as the representative point R. Alternatively, for example, the most important position in the 3D model MO21 is set as the representative point R. For example, when the 3D model MO21 is a person, a center of a face of the person is set as the representative point R.

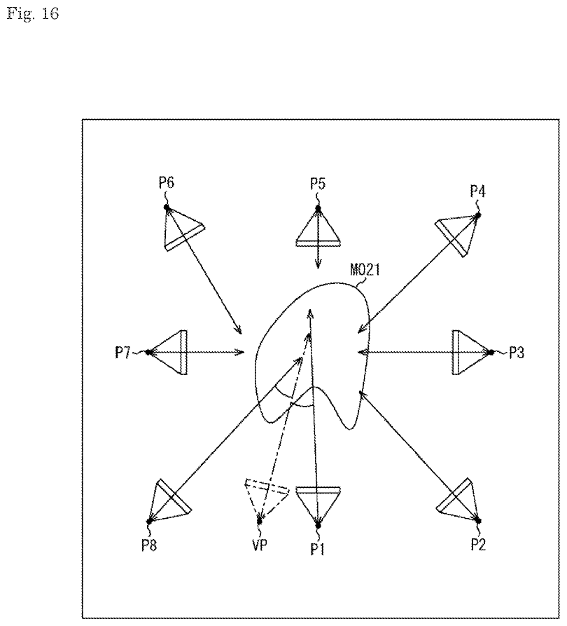

In FIG. 16, an example in which the importance P(i) of each of the optimized viewpoints P1 to P8 is calculated on the basis of an angle formed by a vector indicating a direction of each of the optimized viewpoints P1 to P8 and a vector indicating a direction of the viewing viewpoint VP is shown. In this case, the importance P(i) is calculated by using Equation (3) below.

P(i)=1/arc cos(Zi·Zv) (3)

Here, Zi indicates a vector indicating a direction of the optimized viewpoint Pi. Zv indicates a vector indicating the direction of the viewing viewpoint VP. Zi·Zv indicates an inner product of the vector Zi and the vector Zv.

Therefore, the importance P(i) is inversely proportional to the angle formed by the vector Zi and the vector Zv, and the importance P(i) becomes higher when the angle formed by the vector Zi and the vector Zv is smaller. That is, when the optimized viewpoint has the direction closer to the viewing viewpoint, the importance P(i) becomes higher.

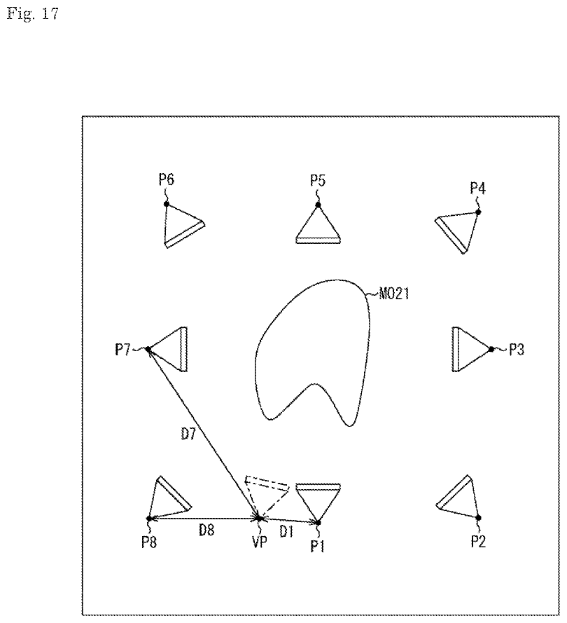

FIG. 17 illustrates an example of calculating the importance P(i) on the basis of a distance between each of the optimized viewpoints P1 to P8 and the viewing viewpoint VP. In this case, the importance P(i) is calculated by using Equation (4) below, for example.

P(i)=1−Di/ΣDi (4)

Here, Di indicates a distance between the optimized viewpoint Pi and the viewing viewpoint VP.

Therefore, when the optimized viewpoint is closer to the viewing viewpoint VP, the importance P(i) increases.

The UV texture selection and transfer unit 62 of FIG. 14 selects the UV texture information from among the plurality of pieces of UV texture information on the basis of such importance P(i) and supplies the UV texture information to the viewing viewpoint image generation unit 64. When the plurality of pieces of UV texture information is transferred to the GPU memory at the point in time of reception, the processing for transferring the UV texture information can be omitted.

The blend coefficient calculation unit 63 calculates the blend coefficient of UV texture information according to the viewing viewpoint. When there is only one piece of UV texture information selected by the UV texture selection and transfer unit 62, this processing can be omitted.

Specifically, first, the blend coefficient calculation unit 63 calculates the importance P(i) using the same method as the method of calculating the importance P(i) in the UV texture selection and transfer unit 62. The blend coefficient calculation unit 63 sets, for example, a blend coefficient for blending of UV texture information optimized for the respective optimized viewpoints at a ratio according to each importance P(i), for each optimized viewpoint selected by the UV texture selection and transfer unit 62.

For example, when the UV texture information optimized for the optimized viewpoints with the importance P(i) up to top two importance P(i) is selected by the UV texture selection and transfer unit 62, the blend coefficient blend_1st of the UV texture information optimized for the optimized viewpoint with the top one importance P(i) is expressed by Equation (5) below.

blend_1st=P(1st)/(P(1st)+P(2nd)) (5)

Here, P(1st) indicates top 1 importance P(i), and P(2nd) indicates top 2 importance P(i).

The blend coefficient blend_1st may be set to gradually increase with the passage of viewing time. In this case, the blend coefficient blend_1st is expressed by Equation (6) below.

Blend_1st=min(P(1st)/(P(1st)+P(2nd))+blend_offset,1.0) (6)

Here, the blend offset coefficient blend_offset is an offset coefficient that increases with the passage of viewing time.

Further, a blend coefficient blend_2nd of the UV texture information optimized for the optimized viewpoint with the top two importance P(i) is expressed by Equation (7) below.

blend_2nd=1−blend_1st (7)

For example, when the UV texture information optimized for the optimized viewpoints with the importance P(i) up to top two importance P(i) is selected by the UV texture selection and transfer unit 62, the blend offset coefficient blend_offset is expressed by Equation (8) below.

blend_offset=min(gain*time_offset,1.0) (8)

Here, gain indicates an addition coefficient per unit time, and time_offset indicates an elapsed time from a timing when the optimized viewpoint with the top one importance P(i) is interchanged.

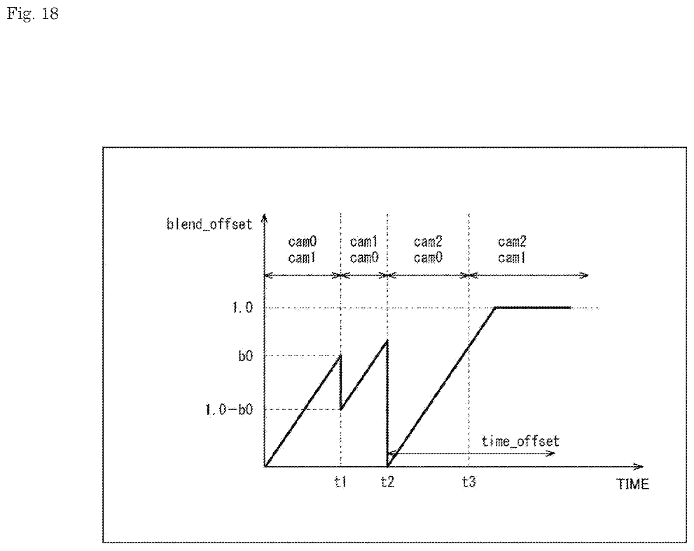

FIG. 18 is a diagram illustrating an example of the blend offset coefficient blend_offset according to the passage of viewing time.

In FIG. 18, a vertical axis indicates a value of the blend offset coefficient blend_offset, and a horizontal axis indicates time. Further, imaging devices cam installed at optimized viewpoints with the importance P(i) up to top two importance P(i) are shown on the upper side of FIG. 18.

In a period from the start of viewing to a time t1, an imaging device cam0 becomes an imaging device installed at the optimized viewpoint with the top one importance P(i), and the imaging device cam1 becomes an imaging device installed at the optimized viewpoint with the top two importance P(i).

In a period up to time t1, the value of the blend offset coefficient blend_offset increases from 0 according to an addition coefficient gain, and becomes b0 at a timing of time t1.

At a timing of time t1, the optimized viewpoint with the top one importance P(i) and the optimized viewpoint with the top two importance P(i) are interchanged. Accordingly, in a period from time t1 to time t2, the imaging device cam1 becomes an imaging device installed at the optimized viewpoint with the top one importance P(i), and the imaging device cam0 becomes an imaging device installed at the optimized viewpoint with the top two importance P(i).

The value of the blend offset coefficient blend_offset is reset to 1−b0 according to the fact that the optimized viewpoint with the top one importance P(i) and the optimized viewpoint with the top two importance P(i) have been interchanged. In the period from time t1 to time t2, the value of the blend offset coefficient blend_offset increases from 1−b0 according to the addition coefficient gain.

At a timing of time t2, the optimized viewpoint with the top one importance P(i) and an optimized viewpoint with the top three or less importance P(i) are interchanged. Accordingly, in a period from time t2 to time t3, the imaging device cam2 becomes an imaging device installed at the optimized viewpoint with the top one importance P(i).

The value of the blend offset coefficient blend_offset is reset to 0 according to the fact that the optimized viewpoint with the top one importance P(i) and the optimized viewpoint with the top three or less importance P(i) have been interchanged. In the period from time t2 to time t3, the value of the blend offset coefficient blend_offset increases from 0 according to the addition coefficient gain.

At a timing of time t3, the optimized viewpoint with the top two importance P(i) and the optimized viewpoint with the top three or less importance P(i) are interchanged. Accordingly, in a period after the time t3, the imaging device cam1 becomes an imaging device installed at the optimized viewpoint with the top two importance P(i).

When the optimized viewpoint with the top two importance P(i) and the optimized viewpoint with the top three or less importance P(i) are interchanged, the value of the blend offset coefficient blend_offset is not reset and increases according to the addition coefficient gain.

When the value of the blend offset coefficient blend_offset becomes an upper limit of 1, the blend coefficient is calculated with the value of the blend offset coefficient blend_offset as 1 until the optimized viewpoint with the top one importance P(i) is interchanged. That is, the camera texture included in the UV texture information optimized for the optimized viewpoint close to the viewing viewpoint (with top one importance P(i)) is pasted to the 3D model.

When the viewing viewpoint is set to a position in the middle of a plurality of optimized viewpoints, quality of the texture pasted to the 3D model may conspicuously deteriorate in the viewing viewpoint image. The reproduction device 2 gradually switches the texture pasted to the 3D model to the camera texture included in the UV texture information optimized for the optimized viewpoint close to the viewing viewpoint, thereby making the deterioration of the texture quality inconspicuous.

Returning to the description of FIG. 14, the blend coefficient calculation unit 63 supplies the blend coefficient set for each piece of UV texture information selected by the UV texture selection and transfer unit 62 to the viewing viewpoint image generation unit 64.

The viewing viewpoint image generation unit 64 uses the mesh information supplied from the mesh transfer unit 61, the UV texture information supplied from the UV texture selection and transfer unit 62, and the blend coefficient supplied from the blend coefficient calculation unit 63 to generate an image of the object viewed from the viewing viewpoint as a viewing viewpoint image.

The viewing viewpoint image generated by the viewing viewpoint image generation unit 64 is supplied to the display control unit 23 and displayed on an external display device.

### 3. Operation of Information Processing System

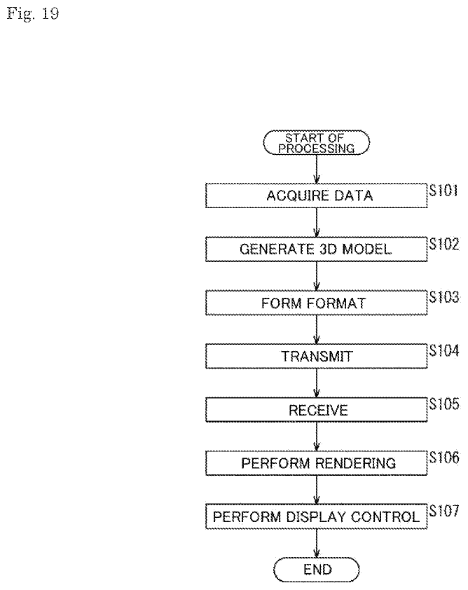

Operation of Entire Information Processing System Next, a flow of processing that is executed by the information processing system will be described with reference to the flowchart of FIG. 19.

When the processing is started, the data acquisition unit 11 acquires image data for generating the 3D model of the object in step S101.

In step S102, the 3D model generation unit 12 generates the model having three-dimensional information of the object on the basis of the image data for generating the 3D model of the object. Further, the 3D model generation unit 12 generates the plurality of pieces of UV texture information optimized for the different angles of view of the optimized cameras on the basis of the image data.

In step S103, the formatting unit 13 encodes a shape of the 3D model generated by the 3D model generation unit 12 and the plurality of pieces of UV texture information into a format suitable for transfer or storage.

In step S104, the transmission unit 14 transfers encoded data, and in step 105, the reception unit 21 receives the transferred data. The reception unit 21 performs decoding processing to perform conversion into a shape required for a display and the plurality of pieces of UV texture information.

In step S106, the rendering unit 22 performs rendering using the shape and the plurality of pieces of UV texture information.

In step S107, the display control unit 23 performs control for displaying the rendering result on the display unit of the display device. When the processing of step S107 ends, the processing of the information processing system ends.

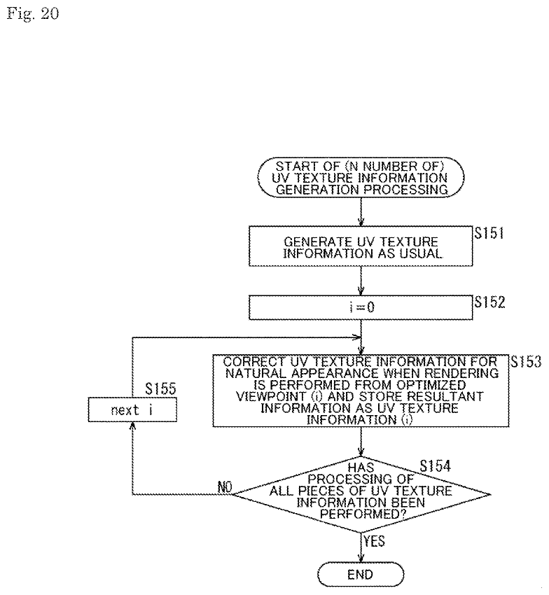

Operation of UV Texture Generation Unit Next, a flow of UV texture information generation processing in a case in which a virtual camera is selected as an optimized camera, which has been described with reference to FIG. 6, will be described with reference to a flowchart of FIG. 20.

The UV texture information generation processing of FIG. 20 is performed in step S102 of FIG. 19 to generate the plurality of pieces of UV texture information.

In step S151, the UV texture generation unit 53 generates UV texture information as usual on the basis of the vertex and face data, the UV map data, and the image data for generating the 3D model of the object.

In step S152, the UV texture generation unit 53 sets the variable i to 0.

In step S153, the UV texture generation unit 53 corrects the UV texture information for a natural appearance when rendering is performed from the optimized viewpoint (i) according to the operation of the user on the distribution side, and stores the resultant information as the UV texture information (i) optimized for the angle of view of the optimized camera (i).

In step S154, the UV texture generation unit 53 determines whether or not the correction processing has been performed on all pieces of UV texture information. For example, when the N pieces of UV texture information optimized for the angle of view of N virtual cameras selected as optimized cameras are stored, it is determined that the correction processing has been performed on all pieces of UV texture information.

When it is determined in step S154 that the correction processing has not been performed on some UV texture information, the processing proceeds to step S155.

In step S155, the UV texture generation unit 53 increments the variable i by one. After the next value is set in the variable i, the processing returns to step S153 and the subsequent processing is performed. That is, UV texture information optimized for the angle of view of the optimized camera (i+1) is generated.

On the other hand, when it is determined in step S154 that the correction processing has been performed on all pieces of UV texture information, the UV texture information generation processing ends, and the processing returns to step S102 in FIG. 9.

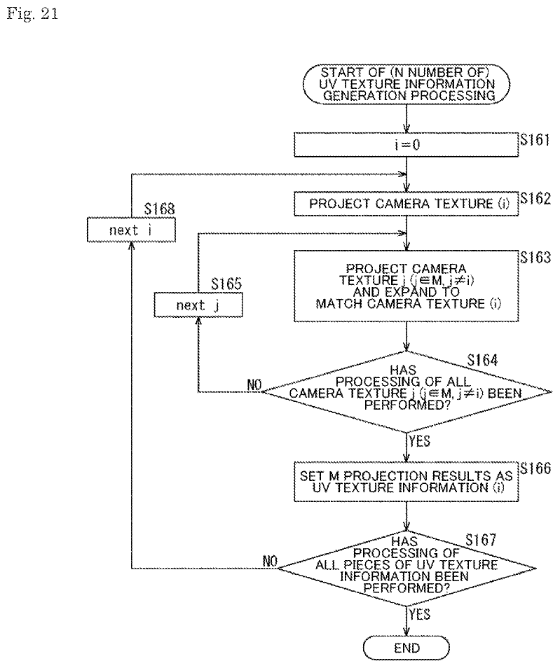

A flow of the UV texture information generation processing in a case in which the imaging device cam is selected as the optimized camera, which has been described with reference to FIG. 7, will be described with reference to the flowchart of FIG. 21. The UV texture information generation processing of FIG. 21 is performed in step S102 of FIG. 19 to generate the plurality of pieces of UV texture information.

In step S161, the UV texture generation unit 53 sets the variable i to 0.

In step S162, the UV texture generation unit 53 projects the camera texture (i) generated by using the captured image obtained by imaging in the imaging device (i) selected as the optimized camera (i) onto the 3D model.

In step S163, the UV texture generation unit 53 projects the camera texture (j) generated by using the captured image obtained by imaging in the imaging device (j), which is one imaging device other than the imaging device (i), onto the 3D model, and performs processing such as stretching to match the camera texture (i).

In step S164, the UV texture generation unit 53 determines whether or not processing has been performed on all the camera textures (j).

When it is determined in step S164 that the processing has not been performed on some of pieces of the camera texture (j), the processing proceeds to step S165.

In step S165, the UV texture generation unit 53 increments the variable j by one. After the next value is set in the variable j, the processing returns to step S163 and the subsequent processing is performed. That is, a camera texture (j+1) is processed to match the camera texture (i).

On the other hand, when it is determined in step S164 that the processing has been performed on all the camera textures (j), the processing proceeds to step S166. For example, when processing is performed on the camera textures of all imaging devices other than the imaging device selected as the optimized camera (i) among M imaging devices installed in an imaging space, it is determined that the processing has been performed on all camera textures (j).

In step S166, the UV texture generation unit 53 uses M results of the projection onto the 3D model as the UV texture information (i) optimized for the angle of view of the optimized camera (i).

In step S167, the UV texture generation unit 53 determines whether or not the processing has been performed on all pieces of UV texture information. For example, when the N pieces of UV texture information optimized for the angle of view of the N imaging devices cam selected as the optimized cameras are stored, it is determined that the processing has been performed on all pieces of UV texture information.

When it is determined in step S167 that the processing has not been performed on some of pieces of UV texture information, the processing proceeds to step S168.

In step S168, the UV texture generation unit 53 increments the variable i by one. After the next value is set in the variable i, the processing returns to step S162 and the subsequent processing is performed. That is, UV texture information optimized for the angle of view of the optimized camera (i+1) is generated.

On the other hand, when it is determined in step S167 that the processing has been performed on all pieces of UV texture information, the UV texture information generation processing ends, and the processing returns to step S102 in FIG. 9.

Operation of UV Texture Selection and Transfer Unit

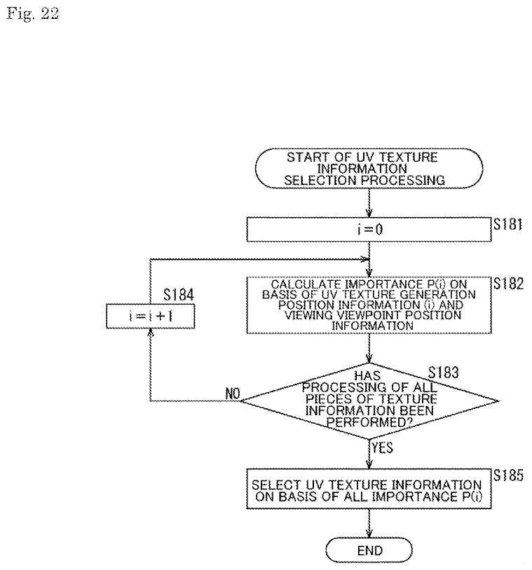

UV texture information selection processing will be described with reference to the flowchart of FIG. 22. The UV texture information selection processing of FIG. 22 is performed in step S106 of FIG. 19 to select the UV texture information to be used for rendering.

In step S181, the UV texture selection and transfer unit 62 sets the variable i to 0.

In step S182, the UV texture selection and transfer unit 62 calculates the importance P(i) of the optimized viewpoint (i) on the basis of the UV texture generation position information (i) indicating the optimized viewpoint (i), and the viewing viewpoint position information.

In step S183, the UV texture selection and transfer unit 62 determines whether or not the processing for calculating the importance P(i) has been performed on all pieces of UV texture information supplied from the reception unit 21.

When it is determined in step S183 that the processing has not been performed on some pieces of UV texture information, the processing proceeds to step S184.

In step S184, the UV texture selection and transfer unit 62 increments the variable i by one. After the next value is set in the variable i, the processing returns to step S182 and the subsequent processing is performed. That is, importance P(i+1) of the optimized viewpoint (i+1) is calculated.

On the other hand, when it is determined in step S183 that the processing has been performed on all pieces of UV texture information, the processing proceeds to step S185.

In step S185, the UV texture selection and transfer unit 62 selects the UV texture information used for generation of the viewing viewpoint image on the basis of all importance P(i). After the UV texture information is selected, the UV texture information selection processing ends, and the processing returns to step S106 of FIG. 9.

Operation of Blend Coefficient Calculation Unit

The blend coefficient calculation processing is performed by the blend coefficient calculation unit 63 in parallel with the UV texture information selection processing of FIG. 22.

The blend coefficient calculation processing is performed as in the flow of the flowchart of FIG. 22 except that the blend coefficient is determined for each optimized viewpoint (i) on the basis of each importance P(i), instead of the UV texture information being selected on the basis of all importance P(i) in step S185 of FIG. 22.

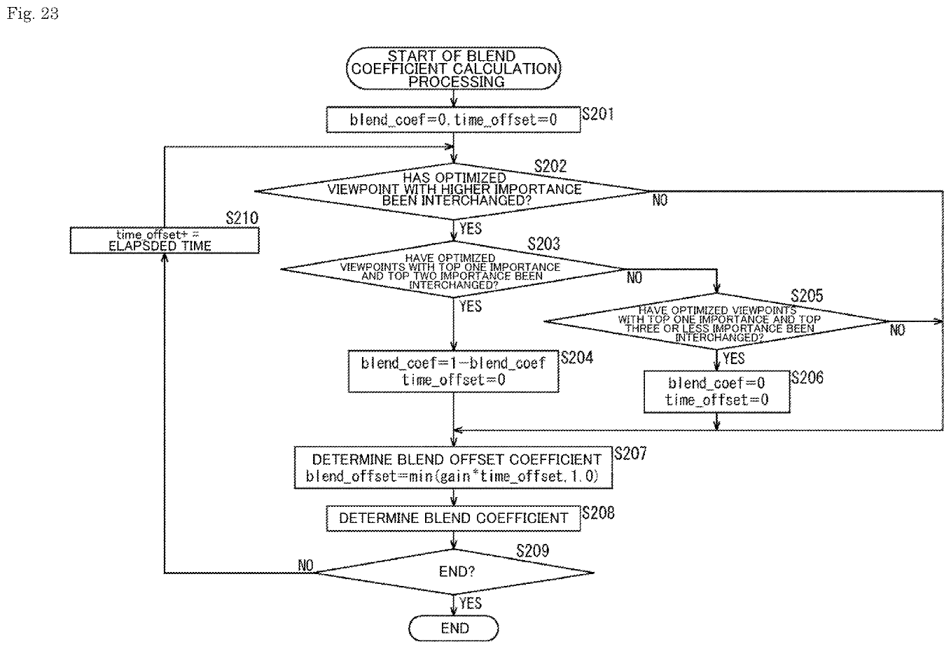

A flow of the blend coefficient calculation processing in a case in which the blend coefficient blend_1st is set to gradually increase with the passage of viewing time, which has been described with reference to FIG. 18, will be described with reference to a flowchart of FIG. 23.

In step S201, the blend coefficient calculation unit 63 sets a value of a blend coefficient blend_coef of the UV texture information optimized for the optimized viewpoint with the top one importance P(i) to 0, and sets a value of a blend offset coefficient time_offset to 0.

In step S202, the blend coefficient calculation unit 63 determines whether or not the optimized viewpoints with higher importance P(i) have been interchanged.

When it is determined in step S202 that the optimized viewpoints with higher importance P(i) have been interchanged, the processing proceeds to step S202.

In step S202, the blend coefficient calculation unit 63 determines whether or not the optimized viewpoint with the top one importance P(i) the optimized viewpoint with the top two importance P(i) have been interchanged.

When it is determined in step S202 that the optimized viewpoint with the top one importance P(i) and the optimized viewpoint with the top two importance P(i) have been interchanged, the processing proceeds to step S204.

In step S204, the blend coefficient calculation unit 63 sets the value of the blend coefficient blend_coef to 1−blend_coef, and sets a value of the blend offset coefficient time_offset to 0.

On the other hand, when it is determined in step S203 that the optimized viewpoint with the top one importance P(i) and the optimized viewpoint with the top two importance P(i) are not interchanged, the processing proceeds to step S205.

In step S205, the blend coefficient calculation unit 63 determines whether or not the optimized viewpoint with the top one importance P(i) and the optimized viewpoint with the top three or less importance P(i) are interchanged.

When it is determined in step S205 that the optimized viewpoint with the top one importance P(i) and the optimized viewpoint with the top three or less importance P(i) are interchanged, the processing proceeds to step S206.

In step S206, the blend coefficient calculation unit 63 sets the value of the blend coefficient blend_coef to 0 and sets the blend offset coefficient time_offset to 0.

On the other hand, when it is determined in step S205 that the optimized viewpoint with the top one importance P(i) and the optimized viewpoint with the top three or less importance P(i) are not interchanged, the processing proceeds to step S207.

When it is determined in step S202 that the optimized viewpoint with the top one importance P(i) and the optimized viewpoint with the top two importance P(i) are not interchanged, or after the processing in step S204 is performed, the processing similarly proceeds to step S207.

In step S207, the blend coefficient calculation unit 63 determines the blend offset coefficient blend_offset according to Equation (8) described above.

In step S208, the blend coefficient calculation unit 63 determines the blend coefficient blend_coef according to Equation (6) described above. Rendering is performed in step S106 of FIG. 19 using the blend coefficient determined in step S208.

In step S209, the blend coefficient calculation unit 63 determines whether or not the blend coefficient calculation processing ends. For example, when the display of the viewing viewpoint image ends, it is determined that the blend coefficient calculation processing ends.

When it is determined in step S209 that the blend coefficient calculation processing does not end, the processing proceeds to step S210.

In step S210, the blend coefficient calculation unit 63 sets an elapsed time from a timing at which 0 is set in the blend offset coefficient time_offset to the value of the blend offset coefficient time_offset. After the value of the blend offset coefficient time_offset is set, the processing returns to step S202, and the subsequent processing is performed.

On the other hand, when it is determined in step S209 that the blend coefficient calculation processing ends, the processing ends.

Operation of Viewing Viewpoint Image Generation Unit

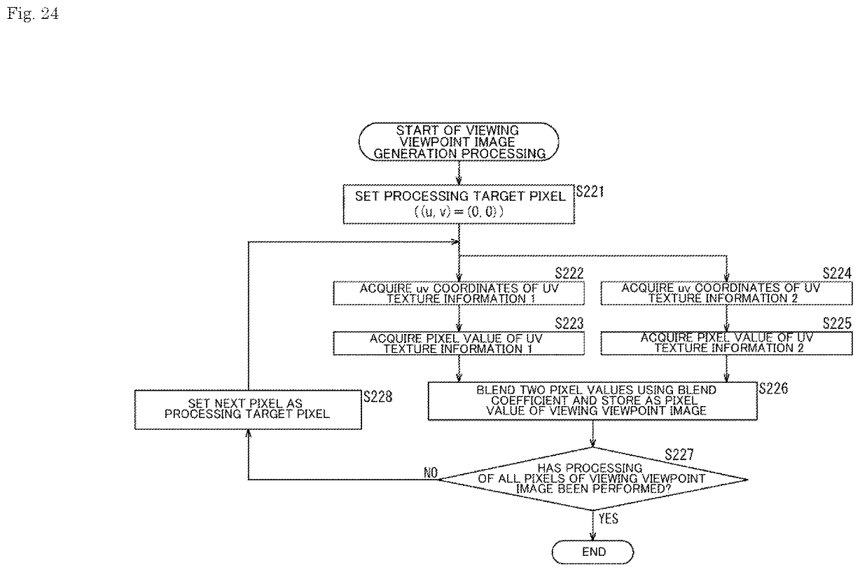

Viewing viewpoint image generation processing will be described with reference to the flowchart of FIG. 24. The viewing viewpoint image generation processing of FIG. 24 is performed to generate the viewing viewpoint image in step S106 of FIG. 19 after the UV texture information selection processing is performed by the UV texture selection and transfer unit 62, and the blend coefficient is determined by the blend coefficient calculation unit 63.

In the following description, it is assumed that UV texture information 1 and UV texture information 2 are selected by the UV texture selection and transfer unit 62.

In step S221, the viewing viewpoint image generation unit 64 sets a processing target pixel. For example, the viewing viewpoint image generation unit 64 sets a pixel at coordinates (u, v)=(0, 0) in the viewing viewpoint image as the processing target pixel.

In step S222, the viewing viewpoint image generation unit 64 acquires uv coordinates of the UV texture information 1 corresponding to coordinates on the 3D model reflected in the processing target pixel.

In step S223, the viewing viewpoint image generation unit 64 acquires a pixel value stored in the uv coordinates of the UV texture information 1 acquired in step S222.

In step S224, the viewing viewpoint image generation unit 64 acquires uv coordinates of the UV texture information 2 corresponding to coordinates on the 3D model reflected in the processing target pixel.

In step S225, the viewing viewpoint image generation unit 64 acquires a pixel value stored at the uv coordinates of the UV texture information 2 acquired in step S224.

The processing of step S224 and step S225 may be performed in parallel with the processing of step S222 and step S223, or may be performed after the processing of step S223 is performed.

In step S226, the viewing viewpoint image generation unit 64 blends the pixel value of the UV texture information 1 and the pixel value of the UV texture information 2 on the basis of the blend coefficient determined by the blend coefficient calculation unit 63, and stores the blended pixel value as the pixel value of the processing target pixel of the viewing viewpoint image.

Specifically, the viewing viewpoint image generation unit 64 multiplies the pixel value of the UV texture information 1 and the pixel value of the UV texture information 2 by the blend coefficient set in each of the UV texture information 1 and the UV texture information 2, and blends the pixel values after multiplication.

In step S227, the viewing viewpoint image generation unit 64 determines whether or not the processing for storing the pixel values has been performed on all the pixels of the viewing viewpoint image.

When it is determined in step S227 that the processing has not been performed on some pixels, the processing proceeds to step S228.

In step S228, the viewing viewpoint image generation unit 64 sets the next pixel as the processing target pixel. After the next pixel is set as the processing target pixel, the processing returns to step S222 and the subsequent processing is performed.

On the other hand, when it is determined in step S227 that the processing has been performed on all the pixels, the viewing viewpoint image generation processing ends, and the processing returns to step S102 in FIG. 9.

Through the above processing, the distribution device 1 can generate 3D data capable of generating a high-quality viewing viewpoint image with a low rendering load.

In the reproduction device 2, processing with a low calculation cost such as switching of UV texture information used for rendering and blending of the plurality of pieces of UV texture information is performed. Therefore, even when the reproduction device 2 is a so-called thin client type device, it is possible to perform real-time reproduction of 3D data.

### 4. Application Example

The technology related to the present disclosure can be applied to various products or services.

(4-1. Production of Content) For example, new video content may be created by synthesizing a 3D model of the subject generated in the present embodiment with the 3D data managed by another server. Further, for example, when background data acquired by an imaging device such as Lidar exists, it is possible to also create content in which the subject appears as if the subject is at a place indicated by the background data by combining the 3D model of the subject generated in the present embodiment with the background data. The video content may be three-dimensional video content or may be two-dimensional video content converted into two dimensions. The 3D model of the subject generated in the present embodiment is, for example, a 3D model generated by the 3D model generation unit or a 3D model reconstructed by the rendering unit.

(4-2. Experience in Virtual Space)

For example, a subject (for example, a performer) generated in the present embodiment can be disposed in a virtual space that is a place at which a user acts as an avatar and performs communication. In this case, the user can act as an avatar and view a live-action subject in the virtual space.

(4-3. Application to Communication with Remote Place)

For example, it is possible for a user at a remote place to view the 3D model of the subject through a reproduction device at the remote place by transmitting the 3D model of the subject generated by the 3D model generation unit from the transmission unit to a remote place. For example, it is possible for the subject and the user at the remote place to perform communication in real time by transferring the 3D model of the subject in real time. For example, a case in which the subject is a teacher and the user is a student, or the subject is a doctor and the user is a patient can be assumed.

(4-4. Others)

For example, it is possible to generate a free viewpoint video of sports or the like on the basis of 3D models of a plurality of subjects generated in the present embodiment, or it is possible for an individual to distribute himself or herself as the 3D model generated in the present embodiment to a distribution platform.

As described above, content of the embodiments described in the present specification can be applied to various technologies or services.

Further, for example, the above-described program may be executed in any device. In that case, the device may have required functional blocks so that the device can obtain required information.

### 5. Computer

The above-described series of processing can be executed by hardware or can be executed by software. When a series of processing are executed by software, a program constituting the software is installed in a computer embedded in dedicated hardware, a general-purpose personal computer, or the like from a program recording medium.

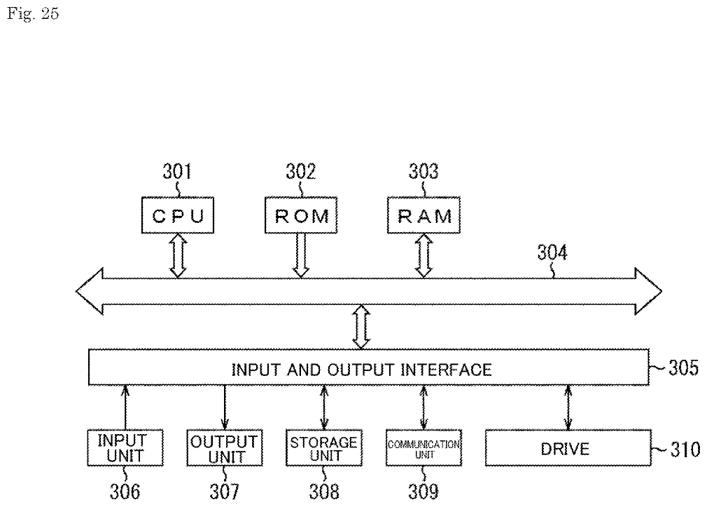

FIG. 25 is a block diagram illustrating a configuration example of computer hardware that executes the above-described series of processing using a program.

In the computer illustrated in FIG. 25, a central processing unit (CPU) 301, a read only memory (ROM) 302, and the random access memory (RAM) 303 are connected to each other via a bus 304.

An input and output interface 305 is also connected to the bus 304. An input unit 306, an output unit 307, a storage unit 308, a communication unit 309, and a drive 310 are connected to the input and output interface 305.

The input unit 306 includes, for example, a keyboard, a mouse, a microphone, a touch panel, or an input terminal. The output unit 307 includes, for example, a display, a speaker, or an output terminal. The storage unit 308 includes, for example, a hard disk, a RAM disk, or a non-volatile memory. The communication unit 309 includes, for example, a network interface. The drive 310 drives a removable medium such as a magnetic disk, an optical disc, a magneto-optical disc, or a semiconductor memory.

In the computer configured as described above, the CPU 301 loads a program stored in the storage unit 308 into the RAM 303 via the input and output interface 305 and the bus 304 and executes the program, so that the above-described series of processing is performed. Further, data and the like necessary for the CPU to execute various types of processing are appropriately stored in the RAM 303.

The program to be executed by the computer, for example, can be recorded on a removable medium such as a package medium and applied. In this case, the program can be installed in the storage unit 308 via the input and output interface by the removable medium being mounted in the drive 310.

This program can also be provided via wired or wireless transfer medium such as a local area network, the Internet, and digital satellite broadcasting. In this case, the program can be received by the communication unit 309 and installed in the storage unit.

Further, for example, each step of one flowchart may be executed by one device, or may be shared and executed by a plurality of devices. Further, when a plurality of processing are included in one step, one device may execute the plurality of processing, or the plurality of devices may share and execute the plurality of processing. In other words, it is also possible to execute the plurality of processing included in one step as processing of a plurality of steps. On the other hand, it is also possible to execute processing described as a plurality of steps collectively as one step.

Further, for example, in a program that is executed by a computer, processing of steps describing the program may be executed in time series in an order described in the present specification, or may be executed in parallel or individually at a required timing such as when call is made. That is, the processing of the respective steps may be executed in an order different from the above-described order as long as there is no contradiction. Further, the processing of the steps describing this program may be executed in parallel with processing of another program, or may be executed in combination with the processing of the other program.

Further, for example, a plurality of technologies regarding the present technology can be independently implemented as a single body as long as there is no contradiction. Of course, it is also possible to perform any plurality of the present technologies in combination. For example, it is also possible to implement some or all of the present technologies described in any of the embodiments in combination with some or all of the technologies described in other embodiments. Further, it is also possible to implement some or all of any of the above-described technologies in combination with other technologies not described above.

<Combination Example of Configuration>

The present technology can also have the following configuration.

(1)

An information processing device including: a generation unit configured to generate a plurality of pieces of texture information corresponding to an image when an object is imaged at a plurality of different viewpoints, from texture information corresponding to 3D shape data indicating a shape of the object.

(2)

The information processing device according to (1), wherein the generation unit generates the plurality of pieces of texture information using camera parameters of a plurality of imaging devices disposed at each of the plurality of viewpoints.

(3)

The information processing device according to (1), wherein the generation unit generates the plurality of pieces of optimized texture information corresponding to the plurality of viewpoints corresponding to angles of view of a plurality of imaging devices configured to image the object.

(4)

The information processing device according to (3), wherein the generation unit generates the texture information corresponding to the viewpoint by processing a texture generated by using an image obtained by imaging in an imaging device other than the imaging device installed at a position corresponding to the viewpoint.

(5)

The information processing device according to any one of (1) to (4), wherein the generation unit further generates the 3D shape data.

(6)

The information processing device according to any one of (1) to (5), wherein the generation unit further generates mapping information indicating a correspondence relationship between the 3D shape data and the plurality of pieces of texture information.

(7)

The information processing device according to (6), wherein the generation unit generates the plurality of pieces of texture information corresponding to common single mapping information.

(8)

The information processing device according to any one of (1) to (7), wherein the generation unit generates the plurality of pieces of texture information as independent data.

(9)

The information processing device according to any one of (1) to (8), wherein the plurality of pieces of texture information is used for generation of a viewing viewpoint image, the viewing viewpoint image being an image of the object from the viewing viewpoint.

(10)

A generation method including: generating a plurality of pieces of texture information corresponding to an image when an object is imaged at a plurality of different viewpoints, from texture information corresponding to 3D shape data indicating a shape of the object.

(11)

An information processing device, including: a rendering unit configured to perform rendering using a plurality of pieces of texture information corresponding to an image when an object is imaged from a plurality of different viewpoints.

(12)

The information processing device according to (11), wherein the rendering unit uses the texture information to generate a viewing viewpoint image, the viewing viewpoint image being an image of an object from the viewing viewpoint.

(13)

The information processing device according to (12), wherein the rendering unit acquires the plurality of pieces of texture information, selects the texture information from the plurality of pieces of texture information on the basis of importance of each of the different viewpoints, and uses the selected texture information to generate the viewing viewpoint image.

(14)

The information processing device according to (13), wherein the rendering unit determines importance of the viewpoint on the basis of the viewpoint and the viewing viewpoint.

(15)

The information processing device according to (14), wherein the rendering unit determines importance of the viewpoint on the basis of an angle formed by a vector from a position of the viewpoint to a position of the object and a vector from a position of the viewing viewpoint to the position of the object.

(16)

The information processing device according to (14), wherein the rendering unit determines importance of the viewpoint on the basis of an angle formed by a vector indicating a direction of the viewpoint and a vector indicating a direction of the viewing viewpoint.

(17)

The information processing device according to (14), wherein the rendering unit determines importance of the viewpoint on the basis of a distance between a position of the viewpoint and a position of the viewing viewpoint.

(18)

The information processing device according to any one of (12) to (17), wherein the rendering unit blends the plurality of pieces of texture information at a ratio according to importance of each of the different viewpoints, and generates the viewing viewpoint image using the texture information obtained by blending.

(19)

The information processing device according to (18), wherein the rendering unit blends the plurality of pieces of texture information by increasing a ratio of the texture information optimized for the viewpoint having the highest importance, among the plurality of pieces of texture information, according to passage of a viewing time.

(20)

A rendering method including: performing rendering using a plurality of pieces of texture information optimized for different viewpoints.

### REFERENCE SIGNS LIST

1 Distribution device
2 Reproduction device
11 Data acquisition unit
12 3D model generation unit
13 Formatting unit
14 Transmission unit
21 Reception unit
22 Rendering unit
23 Display control unit
51 3D model processing unit
52 UV map Generation unit
53 UV texture generation unit
61 Mesh transfer unit
62 UV texture selection and transfer unit
63 Blend coefficient calculation unit
64 Viewing viewpoint image generation unit

1. An information processing device comprising:
a generation unit configured to generate a plurality of pieces of texture information corresponding to an image when an object is imaged at a plurality of different viewpoints, from texture information corresponding to 3D shape data indicating a shape of the object.

2. The information processing device according to claim 1, wherein the generation unit generates the plurality of pieces of texture information using camera parameters of a plurality of imaging devices disposed at each of the plurality of viewpoints.

3. The information processing device according to claim 1, wherein the generation unit generates the plurality of pieces of optimized texture information corresponding to the plurality of viewpoints corresponding to angles of view of a plurality of imaging devices configured to image the object.

4. The information processing device according to claim 3, wherein the generation unit generates the texture information corresponding to the viewpoint by processing a texture generated by using an image obtained by imaging in an imaging device other than the imaging device installed at a position corresponding to the viewpoint.

5. The information processing device according to claim 1, wherein the generation unit further generates the 3D shape data.

6. The information processing device according to claim 1, wherein the generation unit further generates mapping information indicating a correspondence relationship between the 3D shape data and the plurality of pieces of texture information.

7. The information processing device according to claim 6, wherein the generation unit generates the plurality of pieces of texture information corresponding to common single mapping information.

8. The information processing device according to claim 1, wherein the generation unit generates the plurality of pieces of texture information as independent data.

9. The information processing device according to claim 1, wherein the plurality of pieces of texture information are used for generation of a viewing viewpoint image, the viewing viewpoint image being an image of the object from the viewing viewpoint.

10. A generation method comprising:
generating a plurality of pieces of texture information corresponding to an image when an object is imaged at a plurality of different viewpoints, from texture information corresponding to 3D shape data indicating a shape of the object.

11. An information processing device, comprising:
a rendering unit configured to perform rendering using a plurality of pieces of texture information corresponding to an image when an object is imaged from a plurality of different viewpoints.

12. The information processing device according to claim 11, wherein the rendering unit uses the texture information to generate a viewing viewpoint image, the viewing viewpoint image being an image of an object from the viewing viewpoint.

13. The information processing device according to claim 12, wherein the rendering unit acquires the plurality of pieces of texture information, selects the texture information from the plurality of pieces of texture information on the basis of importance of each of the different viewpoints, and uses the selected texture information to generate the viewing viewpoint image.

14. The information processing device according to claim 13, wherein the rendering unit determines the importance of the viewpoint on the basis of the viewpoint and the viewing viewpoint.

15. The information processing device according to claim 14, wherein the rendering unit determines the importance of the viewpoint on the basis of an angle formed by a vector from a position of the viewpoint to a position of the object and a vector from a position of the viewing viewpoint to the position of the object.

16. The information processing device according to claim 14, wherein the rendering unit determines the importance of the viewpoint on the basis of an angle formed by a vector indicating a direction of the viewpoint and a vector indicating a direction of the viewing viewpoint.

17. The information processing device according to claim 14, wherein the rendering unit determines the importance of the viewpoint on the basis of a distance between a position of the viewpoint and a position of the viewing viewpoint.

18. The information processing device according to claim 12, wherein the rendering unit blends the plurality of pieces of texture information at a ratio according to importance of each of the different viewpoints, and generates the viewing viewpoint image using the texture information obtained by blending.

19. The information processing device according to claim 18, wherein the rendering unit blends the plurality of pieces of texture information by increasing a ratio of the texture information optimized for the viewpoint having the highest importance, among the plurality of pieces of texture information, according to passage of a viewing time.

20. A rendering method comprising:
performing rendering using a plurality of pieces of texture information optimized for different viewpoints.
